(19) United States
(12) Patent Application Publication
(10) Pub. No.: US 2026/0298417 A1
(43) Pub. Date: Oct. 1, 2026

(54) APPARATUS CONFIGURED TO CREATE PIPELINE NETWORK DATA WITH WATER LEAKAGE ACCIDENT HISTORY, METHOD FOR CREATING PIPELINE NETWORK DATA WITH WATER LEAKAGE ACCIDENT HISTORY, AND NON-TRANSITORY COMPUTER-READABLE RECORDING MEDIUM

(71) Applicant: Kubota Corporation, Osaka (JP)

(72) Inventors: Yuichi KOBAYASHI, Amagasaki-shi (JP); Hiroaki FUJII, Amagasaki-shi (JP); Yuta OKUMURA, Amagasaki-shi (JP); Sawaka KAWASAKI, Amagasaki-shi (JP)

(21) Appl. No.: 19/678,317

(22) Filed: May 15, 2026

Related U.S. Application Data
(63) Continuation of application No. PCT/JP2024/038925, filed on Oct. 31, 2024.

(30) Foreign Application Priority Data
Dec. 13, 2023 (JP) 2023-209784

(51) Int. Cl. F17D 5/06

(52) U.S. Cl. CPC F17D 5/06

(57) ABSTRACT

An apparatus configured to create pipeline network data with a water leakage accident history includes a processor configured or programmed to include a provisional candidate pipeline selection unit, a candidate pipeline selection unit, and a water leaked pipeline identification unit. The provisional candidate pipeline selection unit is configured or programmed to select a plurality of provisional candidate pipelines located within a predetermined distance from a location of a water leakage accident. The candidate pipeline selection unit is configured or programmed to select from a plurality of provisional candidate pipelines a plurality of candidate pipelines including first attribute data closest to second attribute data of the water leaked pipeline. The water leaked pipeline identification unit is configured or programmed to identify a candidate pipeline closest to the location of the water leakage accident in the plurality of candidate pipelines as the water leaked pipeline.

### CROSS REFERENCE TO RELATED APPLICATIONS

This application claims the benefit of priority to Japanese Patent Application No. 2023-209784 filed on Dec. 13, 2023 and is a Continuation Application of PCT Application No. PCT/JP2024/038925 filed on Oct. 31, 2024. The entire contents of each application are hereby incorporated herein by reference.

### BACKGROUND OF THE INVENTION

### 1. Field of the Invention

The present disclosure relates to apparatuses configured to create pipeline network data with a water leakage accident history, methods for creating pipeline network data with a water leakage accident history, and non-transitory computer-readable media including programs executable to cause a processor to create pipeline network data with a water leakage accident history.

### 2. Description of the Related Art

Japanese National Patent Publication No. 2021-519466 discloses a method for improving piping data for a network of underground piping.

### SUMMARY OF THE INVENTION

Water leakage accident data provided from a customer, such as a water utility, may lack a pipeline ID serving as an identifier of a pipeline that experienced a water leakage accident, and insufficiently identify the address of the pipeline that experienced the water leakage accident. For this reason, the pipeline that experienced the water leakage accident, or a water leaked pipeline, cannot be identified in a pipeline network. Using such water leakage accident data to create a water leakage accident prediction model, a pipeline maintenance plan, and a pipeline renewal plan does not allow the model and plans to have high accuracy.

Example embodiments of the present disclosure provide apparatuses configured to create pipeline network data with a water leakage accident history, methods for creating pipeline network data with a water leakage accident history, and non-transitory computer-readable media including programs executable to cause a processor to create pipeline network data with a water leakage accident history, that each identify a water leaked pipeline more accurately and more quickly.

According to an example embodiment of the present invention, an apparatus configured to create pipeline network data with a water leakage accident history includes a processor configured or programmed to include a pipeline network map creation unit configured or programmed to map, based on locations of a plurality of pipelines and an address of a water leakage accident, the plurality of pipelines and a location of a water leakage accident corresponding to the address of the water leakage accident to create a pipeline network map, the pipeline network data including pipeline IDs, first attribute data, and locations of the plurality of pipelines including latitudes and longitudes of the plurality of pipelines, water leakage accident data including second attribute data of a water leaked pipeline that is a pipeline that experienced the water leakage accident, and the address of the water leakage accident, the water leakage accident data does not include a pipeline ID of the water leaked pipeline and a latitude and longitude of the water leaked pipeline, a provisional candidate pipeline selection unit configured or programmed to select from the plurality of pipelines a plurality of provisional candidate pipelines located within a predetermined distance from the location of the water leakage accident in the pipeline network map, a candidate pipeline selection unit configured or programmed to select from the plurality of provisional candidate pipelines a plurality of candidate pipelines including the first attribute data closest to the second attribute data of the water leaked pipeline, and a water leaked pipeline identification unit configured or programmed to identify a candidate pipeline closest to the location of the water leakage accident in the plurality of candidate pipelines as the water leaked pipeline.

According to an example embodiment of the present invention, a method for creating pipeline network data with a water leakage accident history includes mapping, based on locations of a plurality of pipelines and an address of a water leakage accident, the plurality of pipelines and a location of a water leakage accident corresponding to the address of the water leakage accident to create a pipeline network map, the pipeline network data including pipeline IDs, first attribute data, and locations of the plurality of pipelines including latitudes and longitudes of the plurality of pipelines, water leakage accident data including second attribute data of a water leaked pipeline that is a pipeline that experienced the water leakage accident, and the address of the water leakage accident, the water leakage accident data does not include a pipeline ID of the water leaked pipeline and a latitude and longitude of the water leaked pipeline, selecting from the plurality of pipelines a plurality of provisional candidate pipelines located within a predetermined distance from the location of the water leakage accident in the pipeline network map, selecting from the plurality of provisional candidate pipelines a plurality of candidate pipelines including the first attribute data closest to the second attribute data of the water leaked pipeline, and identifying a candidate pipeline closest to the location of the water leakage accident in the plurality of candidate pipelines as the water leaked pipeline.

According to an example embodiment of the present invention, a non-transitory computer-readable medium includes a program executable to cause a processor to perform each step of a method for creating pipeline network data with a water leakage accident history.

The presently disclosed apparatuses configured to create pipeline network data with a water leakage accident history, methods for creating pipeline network data with a water leakage accident history, and non-transitory computer-readable media including programs executable to cause a processor to create pipeline network data with a water leakage accident history, each identify a water leaked pipeline more accurately and more quickly.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram showing a hardware configuration of an apparatus configured to create pipeline network data with a water leakage accident history according to an example embodiment of the present invention.

FIG. 2 is a block diagram for illustrating a functional configuration of the apparatus configured to create pipeline network data with a water leakage accident history according to an example embodiment of the present invention.

FIG. 3 shows an example of a data structure of pipeline network data.

FIG. 4 shows an example of a data structure of water leakage accident data.

FIG. 5 shows an example of a data structure of map data.

FIG. 6 shows an example of a pipeline network map.

FIG. 7 shows a plurality of provisional candidate pipelines selected from pipelines included in a pipeline network map.

FIG. 8 shows a plurality of candidate pipelines selected from the plurality of provisional candidate pipelines.

FIG. 9 shows a water leaked pipeline identified from the plurality of candidate pipelines.

FIG. 10 shows a table of pipeline network data with a water leakage accident history that is an example of pipeline network data with a water leakage accident history.

FIG. 11 shows a pipeline network map with a water leakage accident history that is an example of pipeline network data with a water leakage accident history.

FIG. 12 shows a flowchart of a method for creating pipeline network data with a water leakage accident history.

FIG. 13 schematically shows a configuration of a system configured to create pipeline network data with a water leakage accident history according to a modification of an example embodiment of the present invention.

### DETAILED DESCRIPTION OF THE EXAMPLE EMBODIMENTS

Hereinafter, example embodiments of the present disclosure will be described. Note that identical components are identically denoted and will not be described repeatedly.

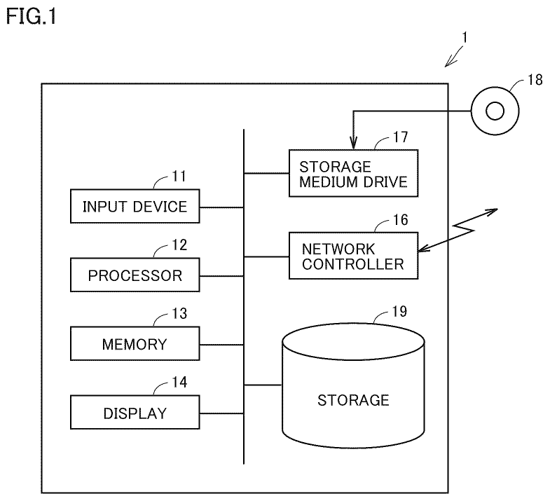

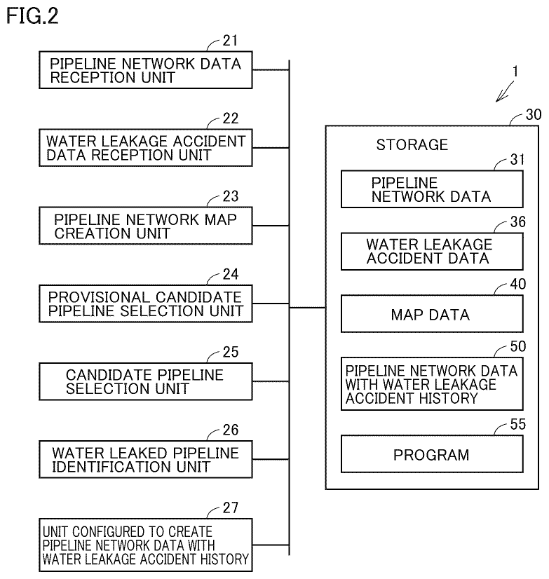

An apparatus 1 configured to create pipeline network data with a water leakage accident history according to an example embodiment of the present invention will be described with reference to FIGS. 1 and 2.

A hardware configuration of apparatus 1 configured to create pipeline network data with a water leakage accident history will be described with reference to FIG. 1. Apparatus 1 configured to create pipeline network data with a water leakage accident history includes an input device 11, a processor 12, a memory 13, a display 14, a network controller 16, a storage medium drive 17, and a storage 19.

Input device 11 receives a variety of types of input operations. Input device 11 is, for example, a keyboard, a mouse, or a touch panel.

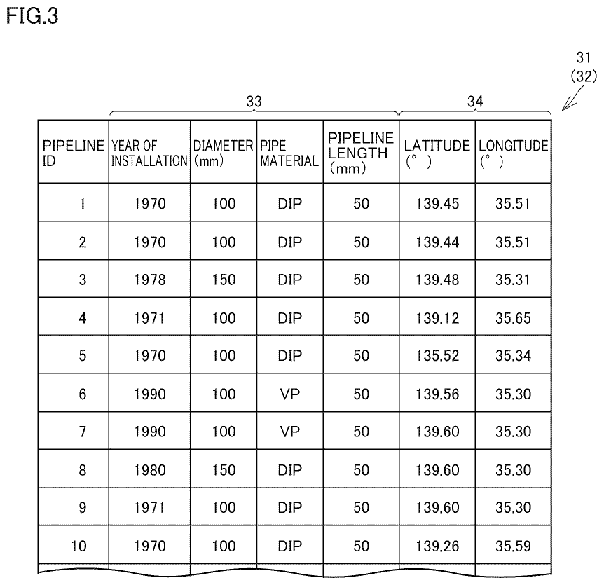

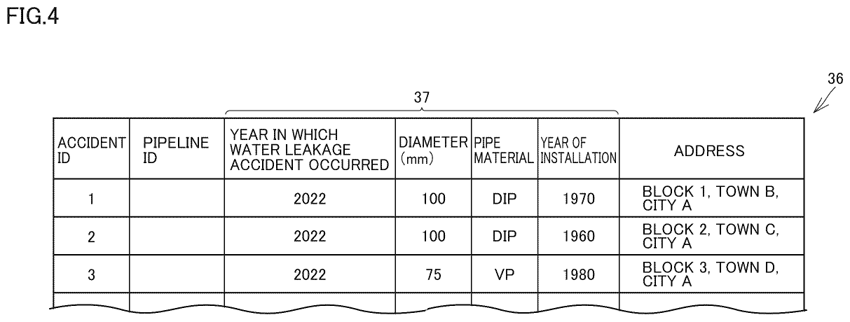

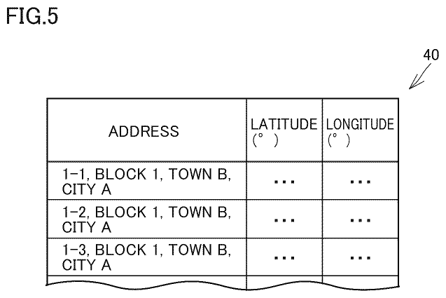

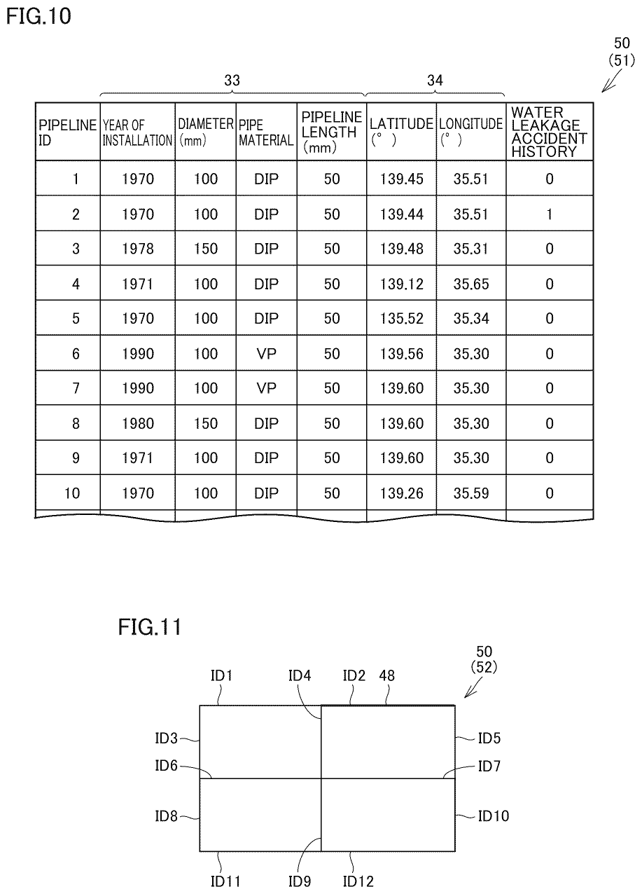

Display 14 displays pipeline network data 31 (see FIG. 3), water leakage accident data 36 (see FIG. 4), map data 40 (see FIG. 5), and other similar information necessary for processing in apparatus 1 configured to create pipeline network data with a water leakage accident history, pipeline network data with a water leakage accident history 50 (see FIGS. 10 and 11), and the like. Display 14 is, for example, an LCD (liquid crystal display) or an organic EL (electroluminescence) display.

Processor 12 executes a program, which will be described hereinafter, to perform a process necessary to perform a function or functions of apparatus 1 configured to create pipeline network data with a water leakage accident history. Processor 12 is configured, for example, by a CPU (central processing unit) or a GPU (graphics processing unit).

Memory 13 provides a storage area in which to temporarily store program code, a work memory, and the like, when processor 12 executes the program. Memory 13 is, for example, a volatile memory device such as a DRAM (dynamic random access memory), an SRAM (static random access memory), etc.

Network controller 16 is configured or programmed to transmit and receive programs or data to and from an external device (not shown) via a communication network (not shown) such as the Internet or an intranet. For example, network controller 16 is configured or programmed to transmit pipeline network data with water leakage accident history 50 (see FIGS. 10 and 11) to the external device via the communication network. Network controller 16 may receive pipeline network data 31 (see FIG. 3) and water leakage accident data 36 (see FIG. 4) from a customer such as a water utility via the communication network. Network controller 16 complies with any communication system such as Ethernet®, wireless LAN, or Bluetooth®, for example.

Storage medium drive 17 is a device that reads a program or data stored in a storage medium 18. Storage medium drive 17 may further be a device that writes a program or data to storage medium 18. Storage medium 18 is a non-transitory storage medium and stores a program or data in a non-volatile manner. Storage medium 18 is, for example, an optical disk (e.g., a CD-ROM or a DVD-ROM) or a similar optical storage medium, a flash memory, a USB memory or a similar semiconductor storage medium, an FD (floppy disk) or a storage tape or a similar magnetic storage medium, or an MO (magneto-optical) disk or a similar magneto-optical storage medium. Pipeline network data 31 (see FIG. 3) and water leakage accident data 36 (see FIG. 4) may be provided from a customer such as a water utility using storage medium 18. Pipeline network data with water leakage accident history 50 (see FIGS. 10 and 11) may be stored in storage medium 18.

Storage 19 is, for example, a non-volatile memory device such as a hard disk or an SSD (solid state drive). Storage 19 stores pipeline network data 31 (see FIG. 3), water leakage accident data 36 (see FIG. 4), map data 40 (see FIG. 5), pipeline network data with water leakage accident history 50 (see FIGS. 10 and 11), a program 55, and the like. Program 55 is executed by processor 12 to perform a function or functions of apparatus 1 configured to create pipeline network data with a water leakage accident history. Program 55 may be stored and distributed in non-transitory storage medium 18, and installed in storage 19. Program 55 may be downloaded via the Internet or an intranet to apparatus 1 configured to create pipeline network data with a water leakage accident history.

In the present example embodiment, a general-purpose computer (processor 12) executes program 55 to perform a function or functions of apparatus 1 configured to create pipeline network data with a water leakage accident history by way of example. Apparatus 1 configured or programmed to create pipeline network data with a water leakage accident history may have a function partially or entirely implemented using an integrated circuit such as an ASIC (application specific integrated circuit) or an FPGA (field programmable gate array).

An example of a functional configuration of apparatus 1 configured to create pipeline network data with a water leakage accident history will now be described with reference to FIG. 2. Apparatus 1 configured to create pipeline network data with a water leakage accident history includes the processor 12 configured or programmed to include a pipeline network data reception unit 21, a water leakage accident data reception unit 22, a pipeline network map creation unit 23, a provisional candidate pipeline selection unit 24, a candidate pipeline selection unit 25, a water leaked pipeline identification unit 26, a unit 27 configured or programmed to create pipeline network data with a water leakage accident history, and a storage 30.

Pipeline network data reception unit 21 is configured or programmed to receive pipeline network data 31 from a customer such as a water utility. Pipeline network data reception unit 21 is configured or programmed to output pipeline network data 31 to storage 30. Pipeline network data 31 is stored in storage 30.

Referring to FIG. 3, pipeline network data 31 is, for example, a pipeline network data table 32. Pipeline network data 31 includes pipeline IDs, first attribute data 33, and locations 34 of a plurality of pipelines configuring a pipeline network. Each pipeline ID is an identifier of a pipeline. Each piece of first attribute data 33 is attribute data of a pipeline, and, for example, includes a diameter, a pipe material, and a year of installation of the pipeline. Each diameter is a diameter of a pipe configuring a pipeline. Each pipe material is a material of a pipe configuring a pipeline, and may be referred to as a pipe type. The pipe material includes a ductile iron pipe (DIP), a cast iron pipe (CIP), an unplasticized poly vinyl chloride pipe (VP), and a steel pipe (SP). Each year of installation is a year in which a pipeline was installed, such as a year in which the pipeline was buried in the ground. First attribute data 33 of each pipeline may further include a pipeline length indicating a length of the pipeline. Location 34 of each pipeline includes a latitude and longitude of the pipeline.

Water leakage accident data reception unit 22 is configured or programmed to receive water leakage accident data 36 from a customer such as a water utility. Water leakage accident data reception unit 22 is configured or programmed to output water leakage accident data 36 to storage 30. Water leakage accident data 36 is stored in storage 30.

Referring to FIG. 4, water leakage accident data 36 includes an accident ID, a pipeline ID of a pipeline that experienced a water leakage accident, hereinafter also referred to as a water leaked pipeline, second attribute data 37, and an address of the water leakage accident. An accident ID is an identifier of a water leakage accident. A pipeline ID of water leakage accident data 36 is a pipeline ID of pipeline IDs of pipeline network data 31 shown in FIG. 3 that identifies a water leaked pipeline. Second attribute data 37, for example, includes a diameter, a pipe material, and a year of installation of a water leaked pipeline. Second attribute data 37 may further include a year in which a water leakage accident occurred. An address of a water leakage accident is an address of a location of the water leakage accident.

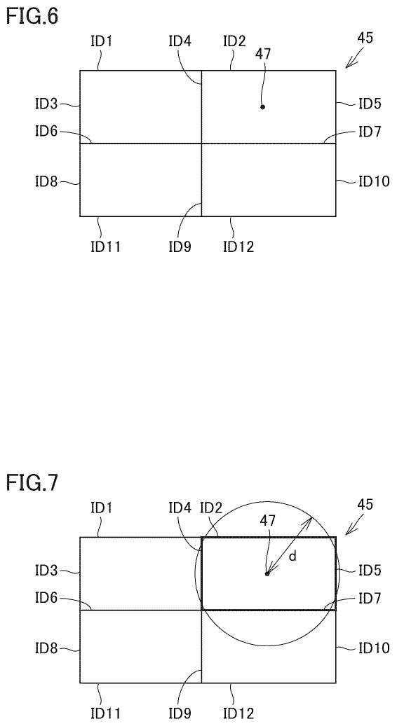

Pipeline network map creation unit 23 is configured or programmed to map, based on locations 34 of the plurality of pipelines (see FIG. 3) and an address of a water leakage accident (see FIG. 4), the plurality of pipelines and a location 47 of a water leakage accident corresponding to the address of the water leakage accident to create a pipeline network map 45 (see FIG. 6). Specifically, pipeline network map creation unit 23 is configured or programmed to read pipeline network data 31, water leakage accident data 36, and map data 40 from storage 30. Referring to FIG. 5, map data 40 includes an address, and a latitude and a longitude. Map data 40 is provided from a public institution or the like through the Internet or storage medium 18, such as through a geographic information system (GIS) or the like, and stored in storage 30. Pipeline network map creation unit 23 is configured or programmed to refer to latitudes and longitudes of pipeline network data 31 and latitudes and longitudes of map data 40 to map a pipeline network including the plurality of pipelines on a map. Pipeline network map creation unit 23 is configured or programmed to refer to an address of water leakage accident data 36 and an address of map data 40 to map location 47 of a water leakage accident on the map. Thus, pipeline network map creation unit 23 is configured or programmed to create pipeline network map 45.

As shown in FIG. 4, water leakage accident data 36 provided from a customer may lack a pipeline ID serving as an identifier of a water leaked pipeline, and insufficiently specify the address of the water leaked pipeline. For example, water leakage accident data 36 provided from a customer may not include a pipeline ID of a water leaked pipeline and a latitude and a longitude of the water leaked pipeline. Water leakage accident data 36 provided from a customer may not specify an address of a water leakage accident for a street number. Furthermore, an area with a low population density may not have an address set sufficiently in detail to identify a pipeline. For this reason, directly reflecting in pipeline network data 31 water leakage accident data 36 provided from a customer may result in location 47 of a water leakage accident deviating from a pipeline, as shown in FIG. 6, and fail to identify the water leaked pipeline.

For example, as shown in FIG. 4 for an accident ID 1, when water leakage accident data 36 does not include a pipeline ID of a water leaked pipeline and only specifies an address of a water leakage accident for a block, pipeline network map creation unit 23 is configured or programmed to designate a center location of the area of the block as location 47 of the water leakage accident. Location 47 of the water leakage accident deviates from a pipeline, and the water leaked pipeline cannot be identified. Even if water leakage accident data 36 provided from a customer lacks a pipeline ID serving as an identifier of a water leaked pipeline and insufficiently identifies the address of the water leaked pipeline, apparatus 1 configured to create pipeline network data with a water leakage accident history can identify the water leaked pipeline with higher accuracy by provisional candidate pipeline selection unit 24, candidate pipeline selection unit 25, and water leaked pipeline identification unit 26, as will described hereinafter.

A water leaked pipeline has a high probability of being located near location 47 of a water leakage accident. Accordingly, as shown in FIG. 7, provisional candidate pipeline selection unit 24 is configured or programmed to select from the plurality of pipelines included in pipeline network data 31 a plurality of provisional candidate pipelines located within a predetermined distance d from location 47 of the water leakage accident in pipeline network map 45. Predetermined distance d is, for example, any distance from 50 m to 200 m. In FIG. 7, for example, four provisional candidate pipelines (pipeline ID 2, pipeline ID 4, pipeline ID 5, and pipeline ID 7) are selected.

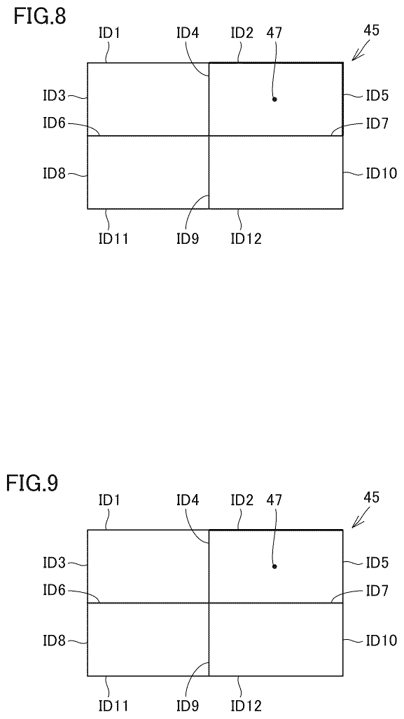

It is highly probable that the water leaked pipeline is one of the plurality of provisional candidate pipelines including first attribute data 33 closest to second attribute data 37 of the water leaked pipeline. Accordingly, as shown in FIG. 8, candidate pipeline selection unit 25 is configured or programmed to select from the plurality of provisional candidate pipelines a plurality of candidate pipelines including first attribute data 33 closest to second attribute data 37 of the water leaked pipeline. For example, candidate pipeline selection unit 25 is configured or programmed to compare first attribute data 33 of the plurality of provisional candidate pipelines with second attribute data 37 of the water leaked pipeline, and to select as a plurality of candidate pipelines any of the plurality of provisional candidate pipelines including a diameter, a pipe material, and a year of installation that match the diameter, pipe material, and year of installation of the water leaked pipeline. In FIG. 8, for example, two candidate pipelines (pipeline ID 2 and pipeline ID 5) are selected.

The water leaked pipeline has a high probability of being located near location 47 of the water leakage accident. Accordingly, as shown in FIG. 9, water leaked pipeline identification unit 26 is configured or programmed to identify a candidate pipeline closest to location 47 of the water leakage accident in the plurality of candidate pipelines as the water leaked pipeline. In FIG. 9, for example, pipeline ID 2 is identified as the water leaked pipeline.

Unit 27 configured or programmed to create pipeline network data with a water leakage accident history creates pipeline network data with water leakage accident history 50 by adding to pipeline network data 31 a water leakage accident history indicating that the identified candidate pipeline of the plurality of pipelines is the water leaked pipeline. Pipeline network data with water leakage accident history 50 may be a table 51 of pipeline network data with a water leakage accident history (see FIG. 10), or may be a pipeline network map 52 with a water leakage accident history (see FIG. 11). Table 51 of pipeline network data with a water leakage accident history and pipeline network map 52 with a water leakage accident history each include pipeline IDs, first attribute data 33, locations 34, and water leakage accident histories for the plurality of pipelines.

Unit 27 configured or programmed to create pipeline network data with a water leakage accident history creates table 51 of pipeline network data with a water leakage accident history (see FIG. 10) by adding the water leakage accident history to pipeline network data table 32 (see FIG. 3). For example, unit 27 configured or programmed to create pipeline network data with a water leakage accident history adds the water leakage accident history to pipeline network data table 32 by inputting “1” in the column of the water leakage accident history at a field of the pipeline identified as the water leaked pipeline by water leaked pipeline identification unit 26, and inputting “0” in the column of the water leakage accident history at a field of a pipeline that is not identified as the water leaked pipeline.

Unit 27 configured or programmed to create pipeline network data with a water leakage accident history creates pipeline network map 52 with the water leakage accident history (see FIG. 11) from map data (see FIG. 5) and table 51 of pipeline network data with a water leakage accident history (see FIG. 10). For example, unit 27 configured or programmed to create pipeline network data with a water leakage accident history maps a pipeline network including a plurality of pipelines on a map with reference to latitudes and longitudes of table 51 of pipeline network data with the water leakage accident history and latitudes and longitudes of map data 40. Unit 27 configured or programmed to create pipeline network data with a water leakage accident history adds to the pipeline network map a water leaked pipeline label 48 indicating that a pipeline indicated in table 51 of pipeline network data with the water leakage accident history including “1” input in the column of the water leakage accident history at the field of the pipeline is the water leaked pipeline. Water leaked pipeline label 48 is an example of a water leakage accident history. Water leaked pipeline label 48 is, for example, indicated by a thick line in FIG. 11.

Unit 27 configured or programmed to create pipeline network data with a water leakage accident history outputs pipeline network data with water leakage accident history 50 to storage 30. Pipeline network data with water leakage accident history 50 is stored in storage 30. Unit 27 configured or programmed to create pipeline network data with a water leakage accident history may output pipeline network data with water leakage accident history 50 to display 14 (see FIG. 1) to cause display 14 to display pipeline network data with water leakage accident history 50. Pipeline network data with water leakage accident history 50 may be provided to a customer through the Internet or storage medium 18.

Storage 30 is implemented by storage 19 (see FIG. 1) or storage medium 18 (see FIG. 1). Storage 30, for example, stores pipeline network data 31, water leakage accident data 36, map data 40, pipeline network data with water leakage accident history 50, and program 55.

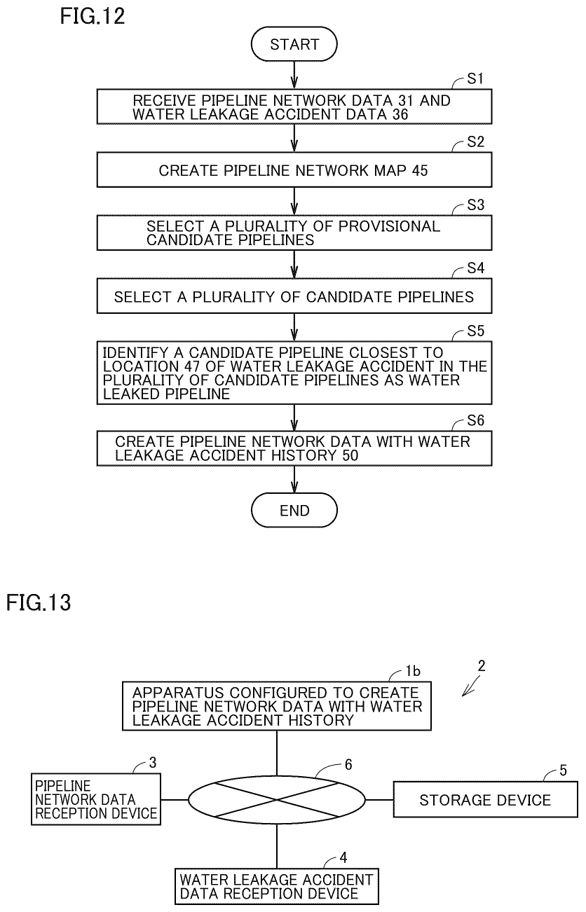

A method for creating pipeline network data with a water leakage accident history according to the present example embodiment will now be described with reference to FIG. 12.

Pipeline network data 31 and water leakage accident data 36 are received from a customer such as a water utility (step S1). Specifically, pipeline network data reception unit 21 receives pipeline network data 31 from the customer. Water leakage accident data reception unit 22 is configured or programmed to receive water leakage accident data 36 from the customer. Pipeline network data 31 and water leakage accident data 36 are provided from the customer through the Internet or storage medium 18. Pipeline network data reception unit 21 is configured or programmed to output pipeline network data 31 to storage 30. Pipeline network data 31 is stored in storage 30. Water leakage accident data reception unit 22 is configured or programmed to output water leakage accident data 36 to storage 30. Water leakage accident data 36 is stored in storage 30.

Referring to FIG. 3, pipeline network data 31 is, for example, pipeline network data table 32. Pipeline network data 31 includes pipeline IDs, first attribute data 33, and locations 34 of a plurality of pipelines configuring a pipeline network. Each pipeline ID is an identifier of a pipeline. Each piece of first attribute data 33 is attribute data of a pipeline, and, for example, includes a diameter, a pipe material, and a year of installation of the pipeline. Each diameter is a diameter of a pipe configuring a pipeline. Each pipe material is a material of a pipe configuring a pipeline, and may be referred to as a pipe type. The pipe material includes a ductile iron pipe (DIP), a cast iron pipe (CIP), an unplasticized poly vinyl chloride pipe (VP), and a steel pipe (SP). Each year of installation is a year in which a pipeline was installed, such as a year in which the pipeline was buried in the ground. First attribute data 33 of each pipeline may further include a pipeline length indicating a length of the pipeline. Location 34 of each pipeline includes a latitude and longitude of the pipeline.

Referring to FIG. 4, water leakage accident data 36 includes an accident ID of a pipeline that experienced a water leakage accident, or a water leaked pipeline, a pipeline ID, second attribute data 37, and an address of the water leakage accident. An accident ID is an identifier of a water leakage accident. A pipeline ID of water leakage accident data 36 is a pipeline ID of pipeline IDs of pipeline network data 31 shown in FIG. 3 that identifies a water leaked pipeline. Second attribute data 37 for example includes a diameter, a pipe material, and a year of installation of a water leaked pipeline. Second attribute data 37 may further include a year in which a water leakage accident occurred. An address of a water leakage accident is an address of a location of the water leakage accident.

Referring to FIGS. 6 and 12, based on locations 34 of the plurality of pipelines (see FIG. 3) and an address of a water leakage accident (see FIG. 4), the plurality of pipelines and location 47 of a water leakage accident corresponding to the address of the water leakage accident are mapped to create pipeline network map 45 (see FIG. 6) (step S2). Specifically, pipeline network map creation unit 23 is configured or programmed to read pipeline network data 31 (see FIG. 3), water leakage accident data 36 (see FIG. 4), and map data 40 (see FIG. 5) from storage 30. Pipeline network map creation unit 23 is configured or programmed to refer to latitudes and longitudes of pipeline network data 31 and latitudes and longitudes of map data 40 to map a pipeline network including the plurality of pipelines on a map. Pipeline network map creation unit 23 is configured or programmed to refer to an address of water leakage accident data 36 and an address of map data 40 to map location 47 of a water leakage accident on the map. Thus, pipeline network map creation unit 23 is configured or programmed to create pipeline network map 45.

As shown in FIG. 4, water leakage accident data 36 provided from a customer may lack a pipeline ID serving as an identifier of a water leaked pipeline, and insufficiently specify the address of the water leaked pipeline. For example, water leakage accident data 36 provided from a customer may not include a pipeline ID of a water leaked pipeline and a latitude and a longitude of the water leaked pipeline. Water leakage accident data 36 provided from a customer may not specify an address of a water leakage accident for a street number. Furthermore, an area with a low population density may not have an address set sufficiently in detail to identify a pipeline. For this reason, directly reflecting in pipeline network data 31 water leakage accident data 36 provided from a customer may result in location 47 of a water leakage accident deviating from a pipeline, as shown in FIG. 6, and fail to identify the water leaked pipeline.

For example, as shown in FIG. 4 for an accident ID 1, when water leakage accident data 36 does not include a pipeline ID of a water leaked pipeline and only specifies an address of a water leakage accident for a block, pipeline network map creation unit 23 is configured or programmed to designate a center location of the area of the block as location 47 of the water leakage accident. Location 47 of the water leakage accident deviates from a pipeline, and the water leaked pipeline cannot be identified. Even if water leakage accident data 36 provided from a customer lacks a pipeline ID serving as an identifier of a water leaked pipeline and insufficiently identifies the address of the water leaked pipeline, the water leaked pipeline can be identified more accurately through the following steps S3 to S5.

A water leaked pipeline has a high probability of being located near location 47 of the water leakage accident. Accordingly, referring to FIGS. 7 and 12, provisional candidate pipeline selection unit 24 is configured or programmed to select from the plurality of pipelines included in pipeline network data 31 a plurality of provisional candidate pipelines located within predetermined distance d from location 47 of the water leakage accident in pipeline network map 45 (step S3). Predetermined distance d is, for example, any distance from 50 m to 200 m. In FIG. 7, for example, four provisional candidate pipelines (pipeline ID 2, pipeline ID 4, pipeline ID 5, and pipeline ID 7) are selected.

It is highly probable that the water leaked pipeline is one of the plurality of provisional candidate pipelines including first attribute data 33 closest to second attribute data 37 of the water leaked pipeline. Accordingly, referring to FIGS. 8 and 12, candidate pipeline selection unit 25 is configured or programmed to select from the plurality of provisional candidate pipelines a plurality of candidate pipelines including first attribute data 33 closest to second attribute data 37 of the water leaked pipeline (step S4). For example, candidate pipeline selection unit 25 is configured or programmed to compare first attribute data 33 of the plurality of provisional candidate pipelines with second attribute data 37 of the water leaked pipeline, and to select as a plurality of candidate pipelines any of the plurality of provisional candidate pipelines including a diameter, a pipe material, and a year of installation that match the diameter, pipe material, and year of installation of the water leaked pipeline. In FIG. 8, for example, two candidate pipelines (pipeline ID 2 and pipeline ID 5) are selected.

The water leaked pipeline has a high probability of being located near location 47 of the water leakage accident. Accordingly, referring to FIGS. 9 and 12, water leaked pipeline identification unit 26 is configured or programmed to identify a candidate pipeline closest to location 47 of the water leakage accident in the plurality of candidate pipelines as the water leaked pipeline (step S5). In FIG. 9, for example, pipeline ID 2 is identified as the water leaked pipeline.

Referring to FIGS. 10 to 12, unit 27 configured or programmed to create pipeline network data with a water leakage accident history creates pipeline network data with water leakage accident history 50 by adding to pipeline network data 31 a water leakage accident history indicating that the identified candidate pipeline of the plurality of pipelines is the water leaked pipeline (step S6). Pipeline network data with water leakage accident history 50 may include table 51 of pipeline network data with a water leakage accident history (see FIG. 10), or may include pipeline network map 52 with a water leakage accident history (see FIG. 11). Table 51 of pipeline network data with a water leakage accident history and pipeline network map 52 with a water leakage accident history each include pipeline IDs, first attribute data 33, locations 34, and water leakage accident histories for the plurality of pipelines.

Unit 27 configured or programmed to create pipeline network data with a water leakage accident history creates table 51 of pipeline network data with a water leakage accident history (see FIG. 10) by adding the water leakage accident history to pipeline network data table 32 (see FIG. 3). For example, unit 27 configured or programmed to create pipeline network data with a water leakage accident history adds the water leakage accident history to pipeline network data table 32 by inputting “1” in the column of the water leakage accident history at a field of the pipeline identified as the water leaked pipeline by water leaked pipeline identification unit 26, and inputting “0” in the column of the water leakage accident history at a field of a pipeline that is not identified as the water leaked pipeline.

Unit 27 configured or programmed to create pipeline network data with a water leakage accident history creates pipeline network map 52 with the water leakage accident history (see FIG. 11) from map data (see FIG. 5) and table 51 of pipeline network data with a water leakage accident history (see FIG. 10). For example, unit 27 configured or programmed to create pipeline network data with a water leakage accident history maps a pipeline network including a plurality of pipelines on a map with reference to latitudes and longitudes of table 51 of pipeline network data with the water leakage accident history and latitudes and longitudes of map data 40. Unit 27 configured or programmed to create pipeline network data with a water leakage accident history adds water leaked pipeline label 48 to the pipeline network map indicating that a pipeline indicated in table 51 of pipeline network data with the water leakage accident history including “1” input in the column of the water leakage accident history at the field of the pipeline is the water leaked pipeline. Water leaked pipeline label 48 is an example of a water leakage accident history. Water leaked pipeline label 48 is, for example, indicated by a thick line in FIG. 11.

Unit 27 configured or programmed to create pipeline network data with a water leakage accident history outputs pipeline network data with water leakage accident history 50 to storage 30. Pipeline network data with water leakage accident history 50 is stored in storage 30. Unit 27 configured or programmed to create pipeline network data with a water leakage accident history may output pipeline network data with water leakage accident history 50 to display 14 (see FIG. 1) to cause display 14 to display pipeline network data with water leakage accident history 50. Pipeline network data with water leakage accident history 50 may be provided to a customer through the Internet or storage medium 18.

Program 55 (see FIG. 2) causes processor 12 (see FIG. 1) to execute each step of a method for creating pipeline network data with a water leakage accident history according to the present example embodiment. Pipeline network data reception unit 21, water leakage accident data reception unit 22, pipeline network map creation unit 23, provisional candidate pipeline selection unit 24, candidate pipeline selection unit 25, water leaked pipeline identification unit 26, and unit 27 configured or programmed to create pipeline network data with a water leakage accident history shown in FIG. 2 are implemented by processor 12 executing program 55.

Program 55 may be stored in a computer-readable storage medium 18 (a non-transitory computer-readable storage medium) according to the present example embodiment.

Referring to FIG. 13, in a modification of the present example embodiment, apparatus 1 configured to create pipeline network data with a water leakage accident history may have a function implemented by a system 2 configured or programmed to create pipeline network data with a water leakage accident history. System 2 configured or programmed to create pipeline network data with a water leakage accident history includes an apparatus 1b configured to create pipeline network data with a water leakage accident history, a pipeline network data reception device 3, a water leakage accident data reception device 4, and a storage device 5. Apparatus 1b configured to create pipeline network data with a water leakage accident history, pipeline network data reception device 3, water leakage accident data reception device 4, and storage device 5 are communicably interconnected through a communication network 6 such as the Internet or an intranet. Apparatus 1b configured to create pipeline network data with a water leakage accident history, pipeline network data reception device 3, and water leakage accident data reception device 4 each have a hardware configuration identical to that shown in FIG. 1. Storage device 5, for example, includes a hard disk or storage medium drive 17.

Apparatus 1b configured to create pipeline network data with a water leakage accident history includes processor 12 configured or programmed to perform a function or functions of pipeline network map creation unit 23 (see FIG. 2), provisional candidate pipeline selection unit 24 (see FIG. 2), candidate pipeline selection unit 25 (see FIG. 2), water leaked pipeline identification unit 26 (see FIG. 2), and unit 27 configured or programmed to create pipeline network data with a water leakage accident history (see FIG. 2). Pipeline network data reception device 3 has a function or functions of pipeline network data reception unit 21 (see FIG. 2). Water leakage accident data reception device 4 has a function or functions of water leakage accident data reception unit 22 (see FIG. 2). Storage device 5 has a function or functions of storage unit 20 (see FIG. 2).

According to the present example embodiment, apparatuses 1, 1b configured to create pipeline network data with a water leakage accident history, the method for creating pipeline network data with a water leakage accident history, and program 55 have an effect as described hereinafter.

According to the present example embodiment, apparatuses 1, 1b configured to create pipeline network data with a water leakage accident history includes processor 12 configured or programmed to include pipeline network map creation unit 23, provisional candidate pipeline selection unit 24, candidate pipeline selection unit 25, and water leaked pipeline identification unit 26. Pipeline network map creation unit 23 maps, based on locations 34 of the plurality of pipelines and an address of a water leakage accident, the plurality of pipelines and location 47 of a water leakage accident corresponding to the address of the water leakage accident to create pipeline network map 45. Pipeline network data 31 includes pipeline IDs, first attribute data 33, and locations 34 of the plurality of pipelines. Locations 34 of the plurality of pipelines include latitudes and longitudes of the plurality of pipelines. Water leakage accident data 36 includes second attribute data 37 of a pipeline that experienced a water leakage accident, or a water leaked pipeline, and an address of the water leakage accident. Water leakage accident data 36 does not include a pipeline ID of the water leaked pipeline and a latitude and longitude of the water leaked pipeline. Provisional candidate pipeline selection unit 24 is configured or programmed to select from the plurality of pipelines a plurality of provisional candidate pipelines located within predetermined distance d from location 47 of the water leakage accident in pipeline network map 45. Candidate pipeline selection unit 25 is configured or programmed to select from the plurality of provisional candidate pipelines a plurality of candidate pipelines including first attribute data 33 closest to second attribute data 37 of the water leaked pipeline. Water leaked pipeline identification unit 26 is configured or programmed to identify a candidate pipeline closest to location 47 of the water leakage accident in the plurality of candidate pipelines as the water leaked pipeline.

Apparatuses 1, 1b configured to create pipeline network data with a water leakage accident history includes processor 12 configured or programmed to include provisional candidate pipeline selection unit 24, candidate pipeline selection unit 25, and water leaked pipeline identification unit 26. Even if a pipeline ID serving as an identifier of a water leaked pipeline lacks and the address of the water leaked pipeline is insufficiently identified, apparatuses 1, 1b configured to create pipeline network data with a water leakage accident history can identify the water leaked pipeline more accurately. As the water leaked pipeline is identified using a computer, rather than manually, the water leaked pipeline can be identified quickly without human error. Furthermore, provisional candidate pipeline selection unit 24, candidate pipeline selection unit 25, and water leaked pipeline identification unit 26 are configured or programmed to narrow down candidates for the water leaked pipeline stepwise, and the water leaked pipeline can be quickly identified even if pipeline network data 31 includes a large number of pipelines including identical attributes.

Pipeline network data with water leakage accident history 50 obtained through apparatuses 1, 1b configured to create the pipeline network data with the water leakage accident history can be used to more accurately create a water leakage accident prediction model, a pipeline maintenance plan, and a pipeline renewal plan more quickly.

For apparatuses 1, 1b configured to create pipeline network data with a water leakage accident history according to the present example embodiment, first attribute data 33 includes diameters, pipe materials, and years of installation of the plurality of pipelines. Second attribute data 37 includes a diameter, a pipe material, and a year of installation of the water leaked pipeline.

Even if a pipeline ID serving as an identifier of a water leaked pipeline lacks and the address of the water leaked pipeline is insufficiently identified, apparatuses 1, 1b configured to create pipeline network data with a water leakage accident history can identify the water leaked pipeline more accurately and more quickly. Pipeline network data with water leakage accident history 50 obtained through apparatuses 1, 1b configured to create the pipeline network data with the water leakage accident history can be used to more quickly create a more accurate water leakage accident prediction model, a more accurate pipeline maintenance plan, and a more accurate pipeline renewal plan.

For apparatuses 1, 1b configured to create pipeline network data with a water leakage accident history according to the present example embodiment, predetermined distance d is any distance from 50 m to 200 m, for example.

Even if a pipeline ID serving as an identifier of a water leaked pipeline lacks and the address of the water leaked pipeline is insufficiently identified, apparatuses 1, 1b configured to create pipeline network data with a water leakage accident history can identify the water leaked pipeline more accurately and more quickly. Pipeline network data with water leakage accident history 50 obtained through apparatuses 1, 1b configured to create the pipeline network data with the water leakage accident history can be used to more quickly create a more accurate water leakage accident prediction model, a more accurate pipeline maintenance plan, and a more accurate pipeline renewal plan.

Apparatuses 1, 1b configured to create pipeline network data with a water leakage accident history according to the present example embodiment further includes unit 27 configured or programmed to create pipeline network data with a water leakage accident history. Unit 27 configured or programmed to create pipeline network data with a water leakage accident history creates pipeline network data with water leakage accident history 50 by adding to pipeline network data 31 a water leakage accident history indicating that the identified candidate pipeline of the plurality of pipelines is the water leaked pipeline.

Pipeline network data with water leakage accident history 50 including data of a water leaked pipeline identified more accurately can be provided to a customer. This allows a more accurate water leakage accident prediction model, a more accurate pipeline maintenance plan, and a more accurate pipeline renewal plan to be created more quickly.

For apparatuses 1, 1b configured to create pipeline network data with a water leakage accident history according to the present example embodiment, pipeline network data with water leakage accident history 50 is table 51 of pipeline network data with a water leakage accident history or pipeline network map 52 with a water leakage accident history, that includes pipeline IDs, first attribute data 33, and locations 34 of the plurality of pipelines, and the water leakage accident history.

Pipeline network data with water leakage accident history 50 including data of a water leaked pipeline identified more accurately can be provided to a customer in a comprehensive manner.

According to the present example embodiment, a method for creating pipeline network data with a water leakage accident history includes the step of mapping, based on locations 34 of the plurality of pipelines and an address of a water leakage accident, the plurality of pipelines and location 47 of a water leakage accident corresponding to the address of the water leakage accident to create pipeline network map 45 (step S2). Pipeline network data 31 includes pipeline IDs, first attribute data 33, and locations 34 of the plurality of pipelines. Locations 34 of the plurality of pipelines include latitudes and longitudes of the plurality of pipelines. Water leakage accident data 36 includes second attribute data 37 of a pipeline that experienced a water leakage accident, or a water leaked pipeline, and an address of the water leakage accident. Water leakage accident data 36 does not include a pipeline ID of the water leaked pipeline and a latitude and longitude of the water leaked pipeline. The method for creating pipeline network data with a water leakage accident history according to the present example embodiment includes selecting from the plurality of pipelines a plurality of provisional candidate pipelines located within predetermined distance d from location 47 of the water leakage accident in pipeline network map 45 (step S3); selecting from the plurality of provisional candidate pipelines a plurality of candidate pipelines including first attribute data 33 closest to second attribute data 37 of the water leaked pipeline (step S4); and identifying a candidate pipeline closest to location 47 of the water leakage accident in the plurality of candidate pipelines as the water leaked pipeline (step S5).

The method for creating pipeline network data with a water leakage accident history according to an example embodiment of the present example embodiment includes selecting a plurality of provisional candidate pipelines from a plurality of pipelines (step S3); selecting a plurality of candidate pipelines from the plurality of provisional candidate pipelines (step S4); and identifying a candidate pipeline closest to location 47 of the water leakage accident in the plurality of candidate pipelines as the water leaked pipeline (step S5). Even if a pipeline ID serving as an identifier of a water leaked pipeline lacks and the address of the water leaked pipeline is insufficiently identified, the water leaked pipeline can be identified more accurately. As the water leaked pipeline is identified using a computer, rather than manually, the water leaked pipeline can be identified quickly without human error. Furthermore, selecting a plurality of provisional candidate pipelines from a plurality of pipelines (step S3); selecting a plurality of candidate pipelines from the plurality of provisional candidate pipelines (step S4); and identifying a candidate pipeline closest to location 47 of the water leakage accident in the plurality of candidate pipelines as the water leaked pipeline (step S5), narrow down candidates for the water leaked pipeline stepwise, and thus quickly identify the water leaked pipeline even if pipeline network data 31 includes a large number of pipelines including identical attributes.

Pipeline network data with water leakage accident history 50 obtained in the method for creating pipeline network data with a water leakage accident history according to the present example embodiment can be used to more accurately create a water leakage accident prediction model, a pipeline maintenance plan, and a pipeline renewal plan more quickly.

In the method for creating pipeline network data with a water leakage accident history according to the present example embodiment, first attribute data 33 includes diameters, pipe materials, and years of installation of the plurality of pipelines. Second attribute data 37 includes a diameter, a pipe material, and a year of installation of the water leaked pipeline.

Even if a pipeline ID serving as an identifier of a water leaked pipeline lacks and the address of the water leaked pipeline is insufficiently identified, the water leaked pipeline can be identified more accurately and more quickly. Pipeline network data with water leakage accident history 50 obtained in the method for creating pipeline network data with a water leakage accident history according to the present example embodiment can be used to more accurately create a water leakage accident prediction model, a pipeline maintenance plan, and a pipeline renewal plan more quickly.

In the method for creating pipeline network data with a water leakage accident history according to the present example embodiment, predetermined distance d is any distance from 50 m to 200 m, for example.

Even if a pipeline ID serving as an identifier of a water leaked pipeline lacks and the address of the water leaked pipeline is insufficiently identified, the water leaked pipeline can be identified more accurately and more quickly. Pipeline network data with water leakage accident history 50 obtained in the method for creating pipeline network data with a water leakage accident history according to the present example embodiment can be used to more accurately create a water leakage accident prediction model, a pipeline maintenance plan, and a pipeline renewal plan more quickly.

The method for creating pipeline network data with a water leakage accident history according to the present example embodiment further includes creating pipeline network data with water leakage accident history 50 by adding to pipeline network data 31 a water leakage accident history indicating that the identified candidate pipeline of the plurality of pipelines is the water leaked pipeline (step S6).

Pipeline network data with water leakage accident history 50 including data of a water leaked pipeline identified more accurately can be provided to a customer. This allows a more accurate water leakage accident prediction model, a more accurate pipeline maintenance plan, and a more accurate pipeline renewal plan to be created more quickly.

In the method for creating pipeline network data with a water leakage accident history according to the present example embodiment, pipeline network data with water leakage accident history 50 is table 51 of pipeline network data with a water leakage accident history or pipeline network map 52 with a water leakage accident history, that includes pipeline IDs, first attribute data 33, and locations 34 of the plurality of pipelines, and the water leakage accident history.

Pipeline network data with water leakage accident history 50 including data of a water leaked pipeline identified more accurately can be provided to a customer in a comprehensive manner.

According to the present example embodiment, program 55 causes processor 12 to execute each step of the method for creating pipeline network data with a water leakage accident history according to the present example embodiment.

Even if a pipeline ID serving as an identifier of a water leaked pipeline lacks and the address of the water leaked pipeline is insufficiently identified, the water leaked pipeline can be identified more accurately and more quickly. Pipeline network data with water leakage accident history 50 obtained by processor 12 executing program 55 according to the present example embodiment can be used to more accurately create a water leakage accident prediction model, a pipeline maintenance plan, and a pipeline renewal plan more quickly.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An apparatus configured to create pipeline network data with a water leakage accident history, the apparatus comprising:
a processor configured or programmed to include:
a pipeline network map creation unit configured or programmed to map, based on locations of a plurality of pipelines and an address of a water leakage accident, the plurality of pipelines and a location of a water leakage accident corresponding to the address of the water leakage accident to create a pipeline network map, the pipeline network data including pipeline IDs, first attribute data, and locations of the plurality of pipelines including latitudes and longitudes of the plurality of pipelines, water leakage accident data including second attribute data of a water leaked pipeline that is a pipeline that experienced the water leakage accident, and the address of the water leakage accident, the water leakage accident data does not include a pipeline ID of the water leaked pipeline and a latitude and longitude of the water leaked pipeline;
a provisional candidate pipeline selection unit configured or programmed to select from the plurality of pipelines a plurality of provisional candidate pipelines located within a predetermined distance from the location of the water leakage accident in the pipeline network map;
a candidate pipeline selection unit configured or programmed to select from the plurality of provisional candidate pipelines a plurality of candidate pipelines including the first attribute data closest to the second attribute data of the water leaked pipeline; and
a water leaked pipeline identification unit configured or programmed to identify a candidate pipeline closest to the location of the water leakage accident in the plurality of candidate pipelines as the water leaked pipeline.

2. The apparatus configured to create the pipeline network data with the water leakage accident history according to claim 1, wherein
the first attribute data includes diameters, pipe materials, and years of installation of the plurality of pipelines; and
the second attribute data includes a diameter, a pipe material, and a year of installation of the water leaked pipeline.

3. The apparatus configured to create the pipeline network data with the water leakage accident history according to claim 1, wherein the predetermined distance is any distance from 50 m to 200 m.

4. The apparatus configured to create the pipeline network data with the water leakage accident history according to claim 1, wherein the processor is configured or programmed to further include a unit configured or programmed to create the pipeline network data with the water leakage accident history by adding to the pipeline network data a water leakage accident history indicating that the identified candidate pipeline of the plurality of pipelines is the water leaked pipeline.

5. The apparatus configured to create the pipeline network data with the water leakage accident history according to claim 4, wherein the pipeline network data with the water leakage accident history includes a table of the pipeline network data with the water leakage accident history or a pipeline network map with the water leakage accident history including the pipeline IDs, first attribute data, and locations of the plurality of pipelines, and the water leakage accident history.

6. A method for creating pipeline network data with a water leakage accident history, the method comprising:
mapping, based on locations of a plurality of pipelines and an address of a water leakage accident, the plurality of pipelines and a location of a water leakage accident corresponding to the address of the water leakage accident to create a pipeline network map, the pipeline network data including pipeline IDs, first attribute data, and locations of the plurality of pipelines including latitudes and longitudes of the plurality of pipelines, water leakage accident data including second attribute data of a water leaked pipeline that is a pipeline that experienced the water leakage accident, and the address of the water leakage accident, the water leakage accident data does not include a pipeline ID of the water leaked pipeline and a latitude and longitude of the water leaked pipeline;
selecting from the plurality of pipelines a plurality of provisional candidate pipelines located within a predetermined distance from the location of the water leakage accident in the pipeline network map;
selecting from the plurality of provisional candidate pipelines a plurality of candidate pipelines including the first attribute data closest to the second attribute data of the water leaked pipeline; and
identifying a candidate pipeline closest to the location of the water leakage accident in the plurality of candidate pipelines as the water leaked pipeline.

7. The method for creating the pipeline network data with the water leakage accident history according to claim 6, wherein
the first attribute data includes diameters, pipe materials, and years of installation of the plurality of pipelines; and
the second attribute data includes a diameter, a pipe material, and a year of installation of the water leaked pipeline.

8. The method for creating the pipeline network data with the water leakage accident history according to claim 6, wherein the predetermined distance is any distance from 50 m to 200 m.

9. The method for creating the pipeline network data with the water leakage accident history according to claim 6, further comprising creating the pipeline network data with the water leakage accident history by adding to the pipeline network data a water leakage accident history indicating that the identified candidate pipeline of the plurality of pipelines is the water leaked pipeline.

10. The method for creating the pipeline network data with the water leakage accident history according to claim 9, wherein the pipeline network data with the water leakage accident history includes a table of the pipeline network data with the water leakage accident history or a pipeline network map with the water leakage accident history including the pipeline IDs, first attribute data, and locations of the plurality of pipelines, and the water leakage accident history.

11. A non-transitory computer-readable recording medium including instructions recorded thereon, that when executed on a processor, perform the method for creating pipeline network data with a water leakage accident history according to claim 6.
